(19) United States
(12) Patent Application Publication
(10) Pub. No.: US 2026/0228223 A1
(43) Pub. Date: Aug. 6, 2026

(54) TABLE CHUNKING FOR DATABASE COMPARISON

(71) Applicant: International Business Machines Corporation, Armonk, NY (US)

(72) Inventors: Hui WANG, Beijing (CN); Yu Mei DAI, Beijing (CN); Xiang Yu XUE, Rizhao City (CN); Mai ZENG, Beijing (CN); Peng Hui JIANG, Beijing (CN); Xiao Chen HUANG, Beijing (CN); Wei LI, Beijing (CN)

(21) Appl. No.: 19/046,954

(22) Filed: Feb. 6, 2025

(51) Int. Cl. G06F 16/2455; G06F 16/22; G06F 16/28

(52) U.S. Cl. CPC G06F 16/24554; G06F 16/2282; G06F 16/285

(57) ABSTRACT

The present disclosure provides a method for improved table chunking for data comparison. The method includes receiving a pair of datasets comprising a source dataset and a target dataset, determining that a data partition configuration table has been defined for the pair of datasets, where the data partition configuration table comprises one or more partitioning rules for dividing the source dataset and the target dataset into one or more partitions, in response to the determination, identifying one or more partitioning attributes within the pair of datasets based on the one or more partitioning rules and determining boundary values for each partitioning attribute to define the one or more partitions, and performing a data comparison between pair of datasets based on the query.

### BACKGROUND

The present disclosure relates to data processing, and more specifically, to facilitating data comparison through improved table chunking.

Active-Active environments and cloud-based systems typically involve database(s) deployed across different sites that work together to serve applications while sharing data. In these environments, maintaining data consistency and accuracy across all database instances is important for system reliability and uninterrupted operations. For example, when unplanned issues like outage occur in a primary site, data synchronization allows the backup site to take over operations immediately with minimal delays and interruptions. Additionally, data synchronization needs to be fast and reliable to allow operations to resume seamlessly after updates or failovers. For example, during a planned upgrade of a primary site, data changes need to be propagated to the other candidate sites after the upgrade is finalized. Once the propagation is complete, the operations with the new updates can be resumed. If data synchronization is slow, it may cause delays to the switchover process, potentially leading to downtime or operational disruptions for users.

### SUMMARY

One embodiment presented in this disclosure provides a method, including receiving a pair of datasets comprising a source dataset and a target dataset, determining that a data partition configuration table exist for the pair of datasets, where the data partition configuration table includes one or more partitioning rules for dividing the source dataset and the target dataset into one or more partitions, in response to the determination, identifying one or more partitioning attributes within the pair of datasets based on the one or more partitioning rules, and determining boundary values for each of the one or more partitioning attributes to define the one or more partitions, generating a query for each partition, the query comprising instructions to retrieve data from the source dataset and the target dataset for each partition based on the one or more partitioning attributes and the corresponding boundary values, and performing a data comparison between pair of datasets based on the query.

Other embodiments in this disclosure provide computer-readable media containing computer program code that, when executed by operation of a computer system, performs operations in accordance with one or more of the above methods, as well as systems comprising one or more memories collectively containing one or more programs, and one or more processors, where the one or more processors are configured to, individually or collectively, perform an operation in accordance with one or more of the above methods.

### BRIEF DESCRIPTION OF THE DRAWINGS

FIG. 1 depicts an example computing environment for the execution of at least some of the computer code involved in performing the inventive methods.

FIG. 2 depicts an example computing system with an active-active architecture, where data is synchronized across multiple production sites, according to some embodiments of the present disclosure.

FIG. 3 depicts an example workflow for data difference detection with improved table chunking, according to some embodiments of the present disclosure.

FIG. 4 depicts an example method for detecting and reporting data differences between pairs of input tables, according to some embodiments of the present disclosure.

FIGS. 5A and 5B depict an example method for determining a chunk-based column list, according to some embodiments of the present disclosure.

FIG. 6 depicts an example method for determining boundary value sets for a selected chunk-based column list, according to some embodiments of the present disclosure.

FIG. 7 is a flow diagram depicting an example method for chunk-based data partitioning, according to some embodiments of the present disclosure.

### DETAILED DESCRIPTION

One embodiment presented in this disclosure provides a method, including receiving a pair of datasets including a source dataset and a target dataset, determining that a data partition configuration table has been defined for the pair of datasets, where the data partition configuration table includes one or more partitioning rules for dividing the source dataset and the target dataset into one or more partitions, in response to the determination, identifying one or more partitioning attributes within the pair of datasets based on the one or more partitioning rules, and determining boundary values for each of the one or more partitioning attributes to define the one or more partitions, generating a query for each partition, the query including instructions to retrieve data from the source dataset and the target dataset for each partition based on the one or more partitioning attributes and the corresponding boundary values, and performing a data comparison between pair of datasets based on the query. The disclosed embodiment enables efficient and scalable data comparison by dividing a large-scale dataset into manageable partitions. The disclosed approach reduces processing time and computational overhead.

In one embodiment, performing the data comparison includes retrieving data for the first partition from the source dataset and the target dataset, determining that one or more discrepancies exist for the first partition by comparing the retrieved data from the source dataset and the target dataset, and in response to the determination, generating a discrepancy report. The disclosed embodiment facilitates efficient comparison and identification of data discrepancies between source and target datasets. By focusing on specific partitions, the disclosed approach reduces resource usage and accelerates the discrepancy detection and reporting operations.

In one embodiment, the method further includes classifying the one or more discrepancies into one or more categories, including at least one of missing records in the target dataset, mismatched values between the source dataset and the target dataset, or extra records in the target dataset, and triggering a remediation operation on the target dataset based on the categorized discrepancies. The disclosed embodiment facilitates targeted and automated remediation to align the target dataset with the source dataset. The categorizing operation provides actionable insights for the identified data discrepancies, and the triggered remediation operation further streamlines the correction process.

In one embodiment, the one or more partitioning rules may include at least one of a rule for selecting a partitioning attribute or a rule for defining a partition size. Through the use of partitioning rules, the disclosed embodiment supports multi-attribute or multi-column partitioning instead of relying solely on key columns or single attributes for partitioning.

In one embodiment, the source dataset and the target dataset each may include a partitioned table, and the process of identifying the one or more partitioning attributes may include at least one of: in response to determining that the source dataset and the target dataset have a shared partitioning key, using the partition key as the partitioning attribute, in response to an absence of the shared partitioning key, using a non-partitioned index (NPI) that spans the source and target datasets as the partitioning attribute, or in response to an absence of the shared partitioning and the NPI, treating the source dataset and the target dataset each as a single partition. The disclosed embodiment facilitates dynamic partitioning attribute selection based on the structure of the target and source datasets. In scenarios where shared partitioning keys and NPIs are available, these attributes are defined as parameters for partitioning. In scenarios where shared partitioning keys and NPIs are not available, the datasets are treated as single partitions to allow the overall data comparison process to proceed without interruption.

In one embodiment, at least one of the source dataset or the target dataset may include a non-partitioned table, and the process of identifying the one or more partitioning attributes may include identifying a plurality of indexes established for the source dataset and the target dataset, in response to determining that the source dataset and the target dataset have one or more shared indexes, among the plurality of indexes, selecting a first index from the one or more shared indexes, where the first index has a lowest number of corresponding columns, and determining the columns corresponding to the first index as the partitioning attributes. The disclosed embodiment facilitates dynamic partitioning attribute selection based on the structure of the target and source datasets. By selecting the index with the lowest number of columns or attributes, the disclosed approach enables data partitioning for non-partitioned tables with reduced complexity.

In one embodiment, at least one of the source dataset or the target dataset may include a non-partitioned table, and the process of identifying the one or more partitioning attributes may include identifying a plurality of indexes established for the source dataset and the target dataset, and in response to an absence of a shared index, among the plurality of indexes, between the source dataset and the target dataset, treating the source dataset and the target dataset each as a single partition. The disclosed embodiment facilitates dynamic partitioning attribute selection based on the structure of the target and source datasets. In scenarios where shared indexes are unavailable, the disclosed approach treats the datasets each as a single partition and enables the overall data comparison process to proceed without interruption.

Other embodiments in this disclosure provide computer-readable media containing computer program code that, when executed by operation of a computer system, performs operations in accordance with one or more of the above methods, as well as systems comprising one or more memories collectively containing one or more programs, and one or more processors, where the one or more processors are configured to, individually or collectively, perform an operation in accordance with one or more of the above methods.

Data synchronization is particularly important for modern active-active environments and cloud-based systems, where data in these systems is distributed, replicated, and shared across multiple instances and locations. In such systems, maintaining data consistency and accuracy is important for reliable operations. The synchronization process typically begins with data comparison, which identifies any inconsistencies or discrepancies between databases. Once these discrepancies are detected, targeted data synchronization may then be conducted to update and correct the datasets to ensure consistency and accuracy across all instances. While data comparison works well for small-sized data, such comparisons become increasingly challenging when dealing with large-scale tables that contain huge volumes of data. The large size of such tables can significantly extend comparison times, leading to delays in the data synchronization process. These delays not only slow down system updates but can also result in resource contention, increased latency, and potential bottlenecks that degrade the overall system performance.

To address these challenges and other relevant concerns, embodiments of the present disclosure introduce methods, systems, and apparatuses for data partitioning, using rules defined in data partition configuration tables to divide large datasets into smaller and more manageable partitions. This approach facilitates improved data comparison and synchronization processes by enabling more efficient handling of data across distributed systems. More specifically, the present method utilizes a table that defines partitioning rules and logic (referred to in some aspects as a “partitioning table” or a “chunk_by table”), where multiple columns may be used as partitioning attributes to allow for dynamic and flexible data partitioning. The partitioning process involves determining boundary values for the selected attributes and generating queries to retrieve specific data partitions for comparison. Unlike conventional approaches, which typically rely solely on key columns or single attributes for partitioning, the present disclosure enables multi-column (or multi-attribute) partitioning to create smaller and more balanced partitions. These smaller partition improves the efficiency of subsequent data comparison and synchronization by reducing processing time and optimizing query execution. The disclosed approach therefore improves overall system performance in active-active and/or cloud-based environments, particularly when handling large-scale and complex datasets.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

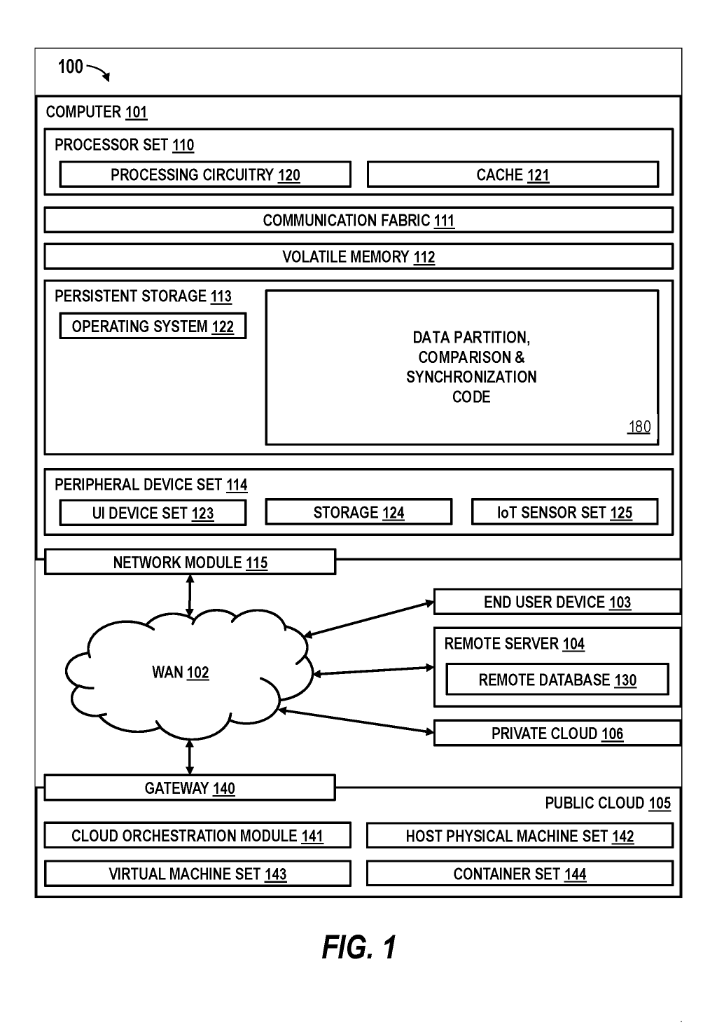

FIG. 1 depicts an example computing environment 100 for the execution of at least some of the computer code involved in performing the inventive methods.

Computing environment 100 contains an example of an environment for the execution of at least some of the computer code involved in performing the inventive methods, such as Data Partition, Comparison, and Synchronization Code 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private cloud 106 and public cloud 105 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

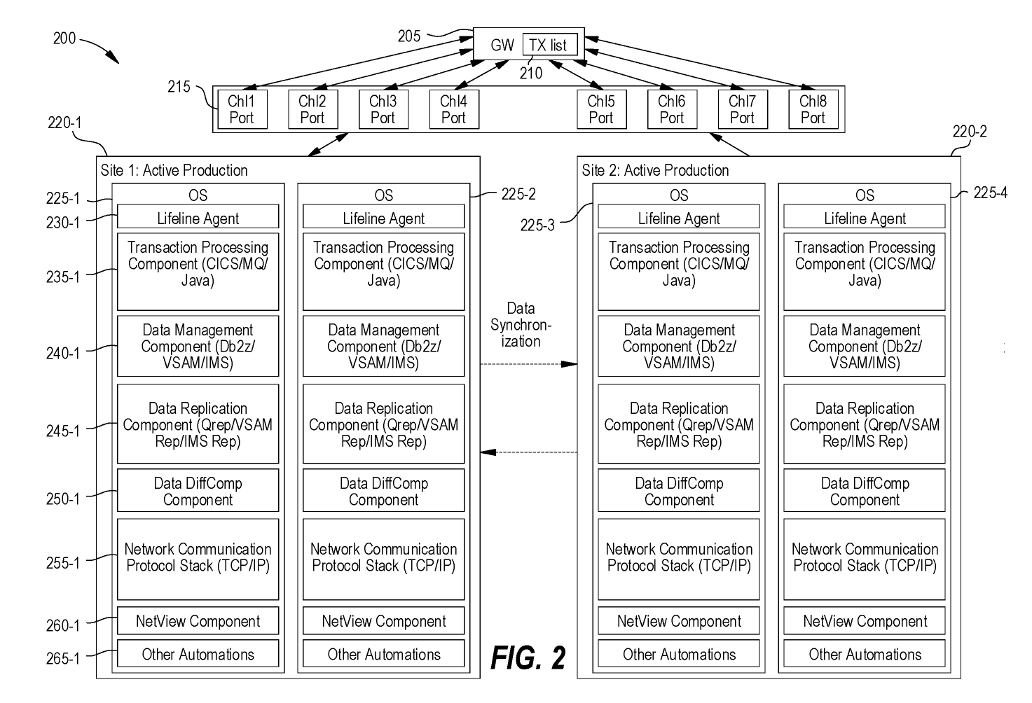

FIG. 2 depicts an example computing system 200 with an active-active architecture, where data is synchronized across multiple production sites 220, according to some embodiments of the present disclosure.

A computing system with an active-active architecture typically includes two or more nodes or sites that work together to serve workloads, transactions, and user requests. This architecture is used in environments that require high availability and reliability with minimal downtime (e.g., e-commerce platform, cloud-based services). In such systems, data is distributed and replicated across multiple active sites to maintain seamless operations and redundancy. However, due to the distributed nature of active-active system, data synchronization is needed to ensure that data across all sites remain consistent and up-to-date. In the event that one node or site fails, the other site, having the up-to-date data, can take over the operations without disruption. In addition, during concurrent transactions or site switches, synchronized data across all sites provides users with a consistent and reliable experience, preventing issues such as data mismatches, duplication, or loss. Without effective synchronization, the advantages of an active-active architecture, such as high reliability and continuous availability, may be compromised.

As depicted, the example active-active computing system includes two production sites (or nodes) 220-1 and 220-2. The two sites are simultaneously active, serving applications and sharing data. Each site includes two operating systems (OS) 225 that actively process workloads and user requests. A gateway (GW) 205 is used to connect the two sites (or nodes), facilitating communications and coordinating operations between the two sites. The gateway 205 manages a transaction list (TX list) 210, which queues transactions for distribution to the two active sites 220. As depicted, the gateway 205 is connected to the production sites 220 via multiple channel ports (CHL ports) 215.

The depiction of each site (or node) 220 including two operating systems 225 is provided for conceptual clarity. In some embodiments, a site (or node) 220 may include any number of operating systems (including one) 225 running on distributed servers or virtual machines. Similarly, the example computing system 200 connecting to two active production sites 220 is provided for conceptual clarity. In some embodiments, the system 200 may be connected to any number of sites or nodes (including one) 220, depending on the scale and requirements of the deployment. These sites 220 may be geographically distributed but logically organized to support large-scale deployments in cloud-based or hybrid infrastructures.

As depicted, each OS 225 in both Site 1 and Site 2 contains several components, including a lifeline agent 230, a transaction processing component 235, a data management component 240, a data replication component 245, a data difference comparison (DiffComp) component 250, a network communication protocol stack 255, a NetView component 260, and one or more other automations 265. Although depicted as discrete components for conceptual clarity, in some embodiments, the operations of the depicted components (and others not illustrated) may be combined or distributed across any number of components.

The described components, such as the lifeline agent 230, transaction processing component 235, data management component 240, data replication component 245, data difference comparison (DiffComp) component 250, network communication protocol stack 255, and NetView component 260, may each represent a collection of software code or programming instructions designed to perform specific tasks. These components work collectively within each OS 225 to enable functions including transaction processing, data comparison, data replication and synchronization, system monitoring, and communication across nodes. The integrated architecture supports the active-active environment by maintaining high availability, reliability, and data consistency across all partitioning sites within the same network.

The lifeline agent 230 is configured to monitor system health and manage the failover process. In some embodiments, the lifeline agent 230 may perform periodic heartbeat checks, and when a failure is detected, the lifeline agent 230 may trigger automated recovery actions. The transaction processing component 235 handles transaction execution and messaging workflows. In some embodiments, the transaction processing component 235 may include systems like customer information control system (CICS) that handles high-performance transaction processing, message queue (MQ) for message delivery between applications, and Java-based system that supports transaction execution in applications. The data management component 240 is designed to manage data storage and retrieval. In some embodiments, the data management component 240 may include systems like Db2z, which provides relational database management for structured data, virtual storage access method (VSAM), which handles file-based datasets on mainframes, and integrated management system (IMS), which supports hierarchical databases and transaction-driven data access. The data replication component 245 is configured to maintain data consistency by replicating changes across active nodes or sites 220. In some embodiments, the data replication component 245 may include systems like Q replication (Qrep) for replicating general data between nodes or sites, VSAM replication (VSAM Rep) for managing file-level replication for VSAM data, and IMS replication (IMS Rep) for synchronizing IMS-managed data across systems.

The data difference comparison (DiffComp) component 250 is configured to perform data difference comparison between datasets to identify discrepancies (e.g., missing, extra, or mismatched records). In some embodiments, the data difference comparison component 250 may first determine the existence of a data partition configuration table (also referred to in some embodiments as a “partitioning table” or a “chunk_by table”). If a data partition configuration table is present, the data DiffComp component 250 follows the rules defined in the table to determine the partitioning attributes (columns) and boundary values. Using these attributes, the data DiffComp component 250 may partition the data into logical chunks and then perform data comparison between these chunks to detect discrepancies. Once detected, the data DiffComp component 250 may generate a detailed report of the discrepancies and forward the report to the data replication component 245 for further actions, such as synchronizing or aligning the dataset across active production nodes or sites 220.

The network communication protocol stack (TCP/IP) 255 provides communication channels between nodes, which enable data exchange, message transmission, and system coordination across the network. The NetView component 260 is configured to monitor and manage network resources and performance. When anomalies are detected, the NetView component 260 facilitates troubleshooting for network-related issues. The one or more other automations 265 refer to additional automation tools and scripts to streamline the operations across the network.

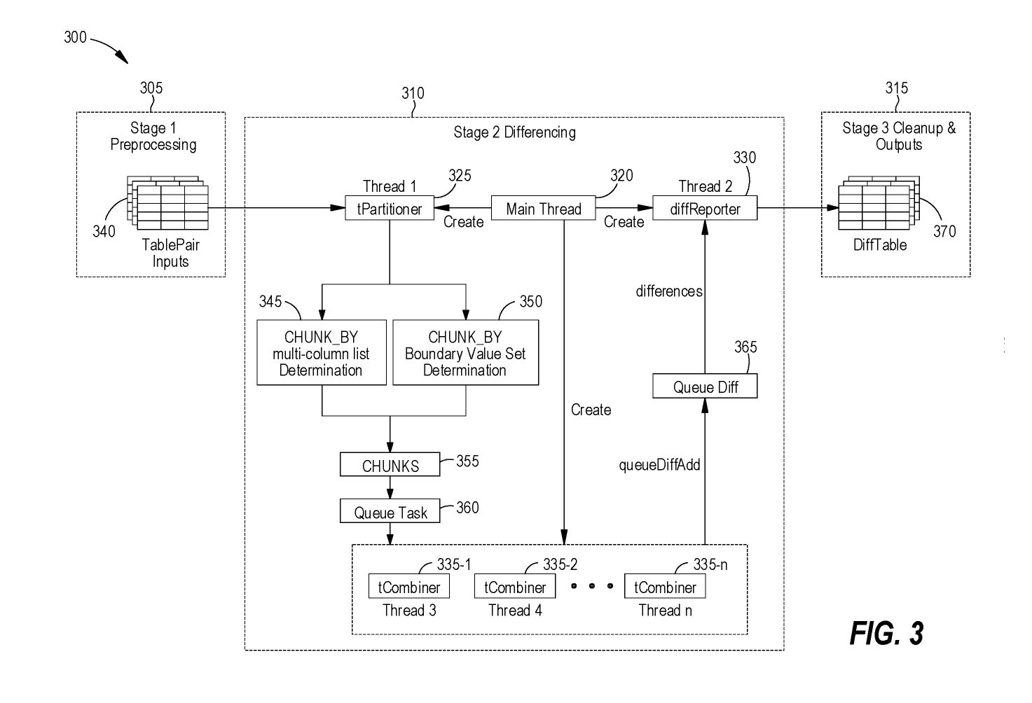

FIG. 3 depicts an example workflow 300 for data discrepancy detection with improved table chunking, according to some embodiments of the present disclosure. In some embodiments, the example workflow 300 may be implemented by the data difference comparison component 250, as depicted in FIG. 2, which operates within the OS instances (e.g., 225 of FIG. 2) of each site in the active-active architecture. Each OS includes similar components configured to collaboratively perform data comparison and synchronization across multiple sites.

As depicted, the workflow 300 includes three stages: Stage 1 (preprocessing) 305, Stage 2 (difference detection) 310, and Stage 3 (cleanup and outputs) 315. In Stage 1 (preprocessing), a pair of input tables, including a source table and a target table, are preprocessed to prepare the data for subsequent comparison. In some embodiments, the source and target tables are from different sites (e.g., 220 of FIG. 2) within an active-active environment, where data is distributed across multiple locations for high availability and fault tolerance. In some embodiments, the source and target tables may reside on different operating systems (OS) within the same site, representing data managed independently within a localized environment. As depicted in FIG. 2, the source table may originate from OS 225-1 in Site 1 (220-1), and the target table may originate from OS 225-3 in Site 2 (220-3). In some embodiments, the preprocessing process may involve confirming the accessibility of the pair of input tables, verifying their structure and schema compatibility, and performing initial data validation to check for issues like missing metadata, inconsistent column types, or unsupported formats. Additionally, duplicate records within each table may be identified and flagged, and relevant transformation(s) (e.g., normalization or data type conversion) may be applied to standardize the input tables. The preprocessing operations are implemented to ensure the source and target tables are in a suitable and consistent state for efficient partitioning and comparison in subsequent stages.

After preprocessing, the workflow 300 enters Stage 2 (difference detection). In this stage, the main thread 320 (also referred to as the parent thread) creates and/or initializes multiple processing threads, including a Partitioner thread 325 (also referred to in some embodiments as “tPartitioner thread”), one or more Combiner threads 335 (e.g., 1-N) (also referred to in some embodiments as “tCombiner thread”), and a DiffReporter thread 330 (also referred to in some embodiments as “tDiffReporter thread”), to handle data partitioning, data comparison, and discrepancy aggregation, respectively. As used herein, the thread refers to a lightweight execution unit or microprocessor engine capable of performing specific tasks within the data discrepancy detection workflow. Each thread operates as a part of the overall multi-threaded architecture to improve efficiency. As used herein, the Partitioner thread 325 is designed to partition the input tables into logical chunks. The 1-N Combiner threads 335 are configured to perform parallel data comparison between corresponding partitions. The DiffReporter thread 330 is designed to aggregate and process discrepancies detected during comparison.

As depicted, the preprocessed input tables 340, including a source table and a target table, are first provided to the Partitioner thread 325. Upon receiving these tables, the Partitioner thread determines whether a data partition configuration table (also referred to in some embodiments as a “partitioning table” or a “chunk_by table”) has been defined for partitioning the pair of input tables 340.

As used herein, a data partition configuration table specifies broad partitioning rules that define how the input tables should be divided into smaller and similar-sized chunks. Unlike conventional methods, which rely on partitioning keys specified by predefined sorting criteria (e.g., the order_by clause of the input tables), the data partition configuration table allows for more flexible and efficient partitioning. Conventional methods typically partition data based on predefined partitioning keys (e.g., for partitioned tables) or alternative logic (e.g., for non-partitioned tables). However, these keys are not always unique. Additionally, tables with a large number of partitioning key columns (or attributes) (e.g., a partitioned table with 15 key columns) may result in SQL queries that are excessively large (e.g., exceeding 32K characters). These large queries make the data partitioning and subsequent comparison process significantly slower, reducing the system’s efficiency in handling large-scale datasets. In contrast, the data partition configuration table allows for dynamic selection of one or more partitioning columns (or attributes) and enables the generation of smaller and more manageable queries that avoid such limitations.

When the data partition configuration table exists, the Partitioner thread 325 follows the rules to identify one or more partitioning columns (or attributes) to be used for partitioning 345, and calculates the boundary value sets for each partition using the selected columns (or attributes) 350. In some embodiments, the selected columns (or attributes) may not be limited to the predefined partitioning keys. Instead, the data partition configuration table may allow the selection of columns beyond these partitioning keys. In embodiments where the partitioning key set is very large (e.g., a partitioned table with 15 key columns), the data partition configuration table may allow to select a subset of the partitioning keys or to use other multiple columns (or attributes) that may better optimize the partitioning process. If no data partition configuration table is present, the Partitioner thread 325 falls back to the conventional partitioning approach, using predefined partitioning keys to segment the data.

With the partitioning attributes and boundary value sets determined, the Partitioner thread 325 proceeds to generate queries (e.g., SQL queries) 355 for each logical chunk. These queries 355 are designed to retrieve data specific to each chunk from the source and target tables. In some embodiments, the Partitioner thread 325 may generate data chunks for processing instead of data queries, depending on the partitioning configuration and system requirements.

As depicted, after generating the chunk queries 355, the Partitioner thread 325 queues these queries for processing. These queued queries 360 are then distributed to one or more Combiner threads 335 for execution. The Combiner threads 335 (from 335-1 to 335-n) work in parallel. Each Combiner thread 335 executes a corresponding query to fetch partitioned data from the source and target tables. The Combiner thread 335 then performs comparison operations on the retrieved data to detect discrepancies, such as missing, extra, or mismatched records. If discrepancies are detected, the Combiner thread 335 queues these discrepancies 365 and sends the list of discrepancies to the DiffReporter thread 330. If no discrepancies are found, the Combiner thread 335 moves to the next partition.

As depicted, the queued discrepancies 365 are sent to the DiffReporter thread 330. The DiffReporter thread 330 aggregates and organizes discrepancies reported by multiple Combiner threads (from 335-1 to 335-n), and generates a difference table 370 at Stage 3 (cleanup and outputs). In some embodiments, the difference table 370 may then be forward to other system components, such as the data management component (e.g., 240-1 of FIG. 1) and/or data replication component (e.g., 245-1 of FIG. 1), which perform data synchronization and other corrective actions to resolve the detected discrepancies and align the source and target datasets.

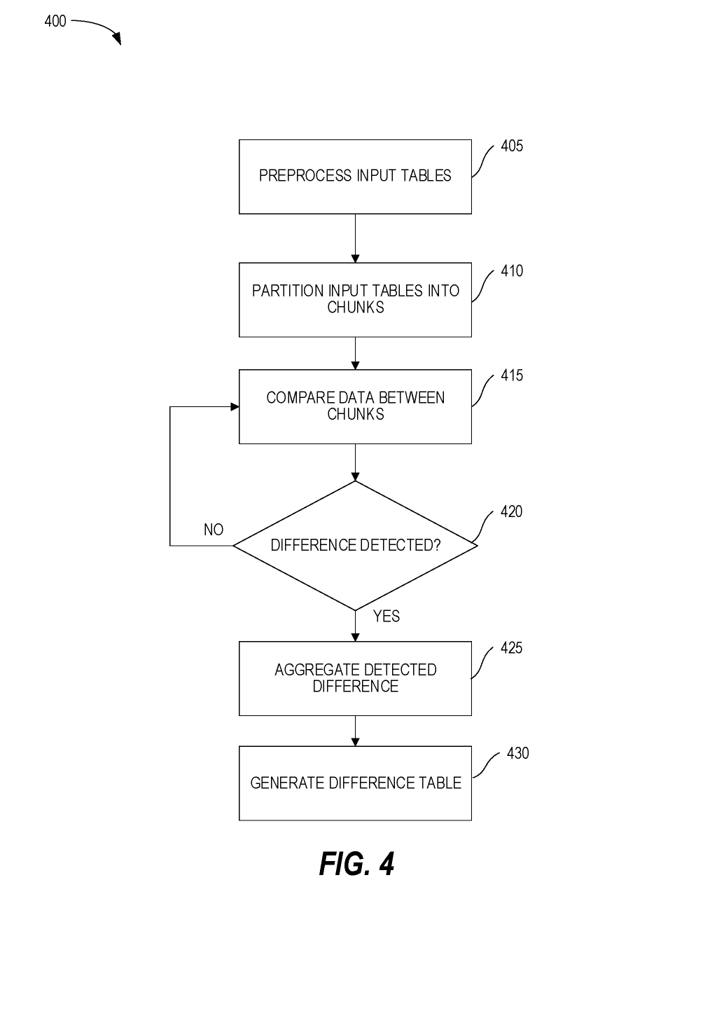

FIG. 4 depicts an example method 400 for detecting and reporting data differences between pairs of input tables, according to some embodiments of the present disclosure. In some embodiments, the example method 400 may be performed by any computing device or system, such as the data difference comparison (DiffComp) component 250 as depicted in FIG. 2.

At block 405, a computing system (e.g., the data difference comparison component 250 of FIG. 2) preprocesses input tables. As discussed above, the pair of input tables may include a source table and a target table, each from different nodes or sites (e.g., 220 of FIG. 2) within an active-active environment. The preprocessing may include verifying that both tables can be accessed without errors, checking the table’s structure to confirm compatibility (e.g., matching column names and data types), cleaning duplicate records, and transforming data types into consistent formats.

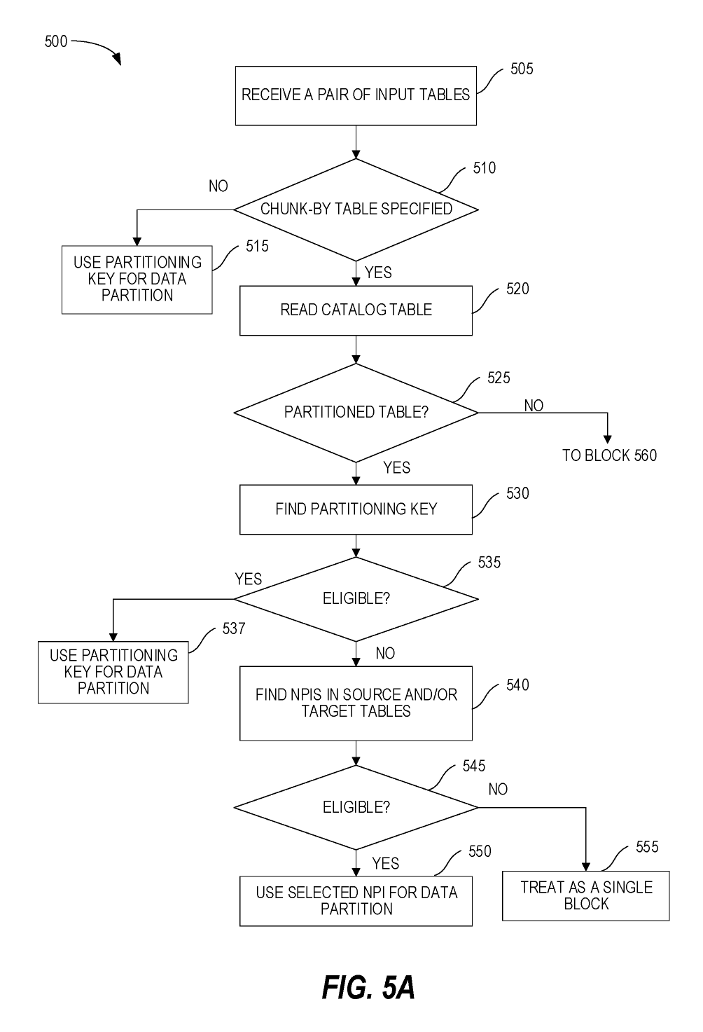

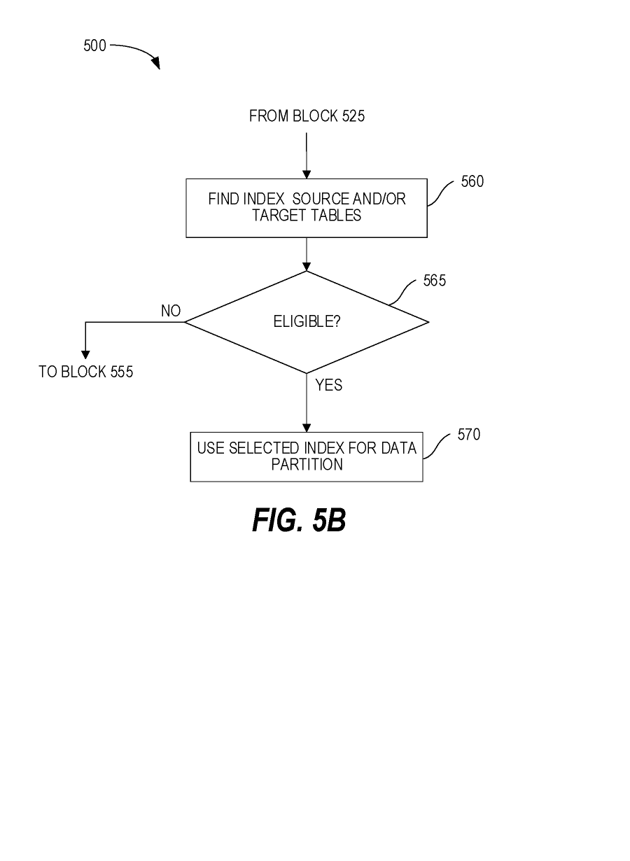

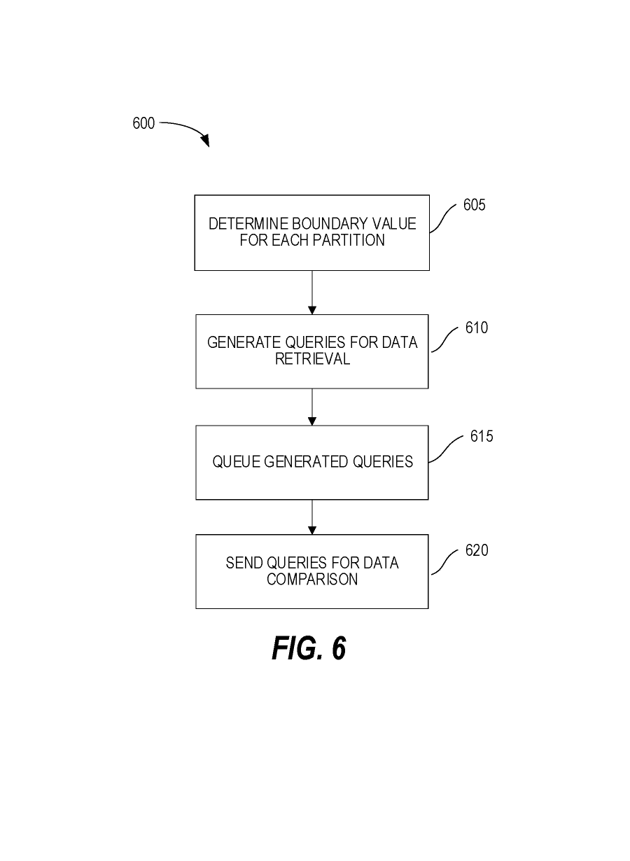

At block 410, the computing system (e.g., via a Paritioner thread) partitions the input tables into smaller and similar-sized chunks based on determined partitioning attributes and boundary value sets. In some embodiments, the partitioning process begins with the system determining whether a data partition configuration table (also referred to in some embodiments as a “chunk_by table”) has been defined for the input tables. If a data partition configuration table exists, the system may use the rules defined within the table to identify partitioning attributes (e.g., specific columns) and calculate boundary value sets for each logical partition. Based on these boundary values, the system generates chunk-specific SQL queries (e.g., which are designed to retrieve data for each partition). Each query is then used to retrieve a respective chunk of data from the corresponding database. For example, one query retrieves a chunk from the source table, while another query retrieves the corresponding chunk from the target table. The retrieved pair of chunks is then compared to detect discrepancies. More details related to chunk-based column selection and boundary value determination are discussed below with reference to FIGS. 5A, 5B and 6.

At block 415, the computing system (e.g., via one or more Combiner threads) performs data comparison for each pair of partitions to detect discrepancies. In some embodiments, the data comparison process may include executing the chunk-specific SQL queries to retrieve data for each partition from the source and target tables. Once the data is retrieved, the system performs record-by-record comparison within each partition to identify potential discrepancies. These discrepancies may include missing records (present in the source table but not the target table), extra records (present in the target table but not the source table), and mismatched values (where corresponding records have different values).

At block 420, the computing system evaluates the results of the data comparison (e.g., performed by the Combiner threads) to determine whether discrepancies exist within the current partition. If discrepancies are detected, the method 400 moves to block 425. If no discrepancies are found, the method 400 returns to block 415, where the system proceeds to process the next data partition.

At block 425, the computing system aggregates and queues the discrepancy details received from one or more Combiner threads. Each Combiner thread may categorize the detected discrepancies based on their type (e.g., missing, extra, or mismatched records) and forwards the discrepancies to the DiffReporter thread.

At block 430, the computing system (e.g., via a DiffReporter thread) compiles the detected discrepancies into a final difference table (e.g., 370 of FIG. 3). The table includes detailed information about each detected discrepancy, such as partition details (e.g., the partition where the discrepancy occurred), discrepancy type (e.g., missing, extra, or mismatched records), and record and column information (e.g., row and column details to identify the exact location of the error). The final difference table offers a clear and structured summary of the detected discrepancies and may then be forwarded to other system components (e.g., data replication component 245-1 of FIG. 2) for data synchronization.

FIGS. 5A and 5B depict an example method 500 for determining a chunk-based column list, according to some embodiments of the present disclosure. The example method 500 may be performed by any computing device or system, such as the tParitioner thread 325 as depicted in FIG. 3.

At block 505, a tParitioner thread (e.g., 325 of FIG. 3) receives a pair of table inputs for partitioning (e.g., 340 of FIG. 3). The pair of table inputs includes a source table and a target table, and has been preprocessed to ensure compatibility for partitioning and comparison. The source and target tables may originate from different nodes or sites (e.g., 220 of FIG. 2) in an active-active environment.

At block 510, the tParitioner thread checks whether a data partition configuration table (also referred to in some embodiments as a “chunk_by table”) is defined for the received input tables. In some embodiments, the data partition configuration table may serve as a metadata-driven configuration that defines high-level partitioning rules for dividing the input tables into smaller and manageable chunks. These rules provide flexibility beyond conventional partitioning approaches by allowing dynamic selection of one or multiple columns and customized partitioning logic. In some embodiments, the data partition configuration table may provide a broad partitioning rule (e.g., “partition by date”). In some embodiments, the data partition configuration table may specify exact columns (e.g., CutomerID, Sale_Date) as partitioning attributes. In some embodiments, the data partition configuration table may further include rules defining partition size (e.g., 10,000 rows per partition) to ensure each partition contains a manageable subset of data. If a data partition configuration table exists, the method 500 proceeds to block 520. If no such table is present, the method 500 moves to block 515, where the Partitioner uses a default partitioning approach, such as using predefined partitioning keys for partitioned tables. In embodiments where either of the input tables is non-partitioned, the tParitioner thread may treat each table as a single logic block without further partitioning for data comparison.

At block 520, the tParitioner thread reads the system catalog table to gather metadata about the input tables, and determines whether the input tables are partitioned or non-partitioned. As used herein, a partitioned table refers to a table that has predefined partitions based on specific attributes or partitioning keys, such as a data column or a geographic region. In contrast, a non-partitioned table (also referred to in some embodiments as a “partition-by-growth table”) refers to a table that does not have predefined partitions and is stored as a single and continuous dataset. Either partitioned or non-partitioned tables may be searched using indexes, which specify one or more attributes (or columns) to facilitate efficient data retrieval. For example, an index like IDX_OrderID may be defined on the OrderID column to quickly locate specific orders, and an index IDX_Region_Date may be defined on both Region and Date columns to efficiently query records associated with a specific geographic region and date range. However, for partitioned tables, both local indexes (aligned with individual partitions) and global indexes (spanning all partitions) may be used. For non-partitioned tables, only global indexes, which cover the entire table, may be used for indexing and search operations.

At block 525, the Partitioner thread evaluates whether both the source and target tables are partitioned. If both tables are determined to be partitioned, the method 500 moves to block 530. If one or both tables are non-partitioned, the method 500 proceeds to block 560 (as depicted in FIG. 5B).

At block 530, the Partitioner thread identifies the predefined partitioning keys for the input tables. These keys are the primary columns or attributes (e.g., Date column, Region column) used to divide the data into partitions based on their structure and organization.

At block 535, the Partitioner thread checks whether the partitioning keys are eligible for both tables (e.g., shared by both source and target tables). If there are shared partitioning keys, the method 500 moves to block 537, where the thread uses the shared keys for data partition. In some embodiments, the operation at block 537 may be performed only when the data partition configuration table does not explicitly specify a rule prohibiting the use of partitioning keys. For example, if the data partition configuration table specifies that partitioning keys should not be used or provides a specific rule to use alternative columns (e.g., specifying only the CustomerID column), the Partitioner thread may follow the rules defined in the data partition configuration table rather than defaulting to the predefined partitioning keys. In embodiments where the tables have a large number of shared partitioning keys (e.g., 12 columns in total), at block 537, the thread may select a subset of the key columns to optimize the partitioning process. The selection is based on predefined rules in the data partition configuration table. For example, if the rule specifies “partitioning by date,” the thread may select only the Date column from the partitioning keys. Compared with conventional approaches that rely on using all partitioning keys (as depicted by block 515), this selective column approach simplifies the generated SQL queries, reducing their complexity and size, and subsequently improves the efficiency in subsequent data retrieval and comparison processes.

If the input tables do not share any common partitioning keys, the method 500 proceeds to block 540. At block 540, the Partitioner thread identifies the non-partitioned index (NPI) defined for the source and/or target tables. The NPI is an index not tied to specific partitions that can be used to identify partitioning attributes even when no partitioning keys are present.

At block 545, the Partitioner thread checks whether any of the identified NPIs are shared by both the source and target tables. If only one NPI exists and is shared by both tables, the Partitioner thread may directly use this NPI as the partitioning attributes (as depicted by block 550). For example, an NPI such as IDX_CustomerID defined on CustomerID column may be shared by both tables. In this configuration, the method moves to block 550, where the system uses the CustomerID column for data partition, such as dividing the data into logical chunks where each chunk corresponds to a range or set of CustomerID values and generating corresponding SQL queries. If multiple NPIs are shared by both tables, the Partitioner thread evaluates these NPIs and selects the one with the fewest columns. For example, two NPIs are shared between the source and target tables, IDX_CustomerID_OrderDate and IDX_CustomerID. The IDX_CustomerID_OrderDate is defined on multiple columns, including CustomerID column and OrderDate column, while the IDX_CustomerID is defined on CustomerID column only. In this configuration, the Partitioner thread selects IDX_CustomerID because it involves fewer columns. The selection of an index with the lowest number of columns simplifies the partitioning process, minimizing (at least reducing) processing overhead and facilitating the generation of more efficient SQL queries for subsequent data comparison. After the NPI with the fewest columns is selected, the method 500 proceeds to block 550, where the system uses the selected NPI for data partition and generating corresponding chunk queries.

If no shared NPI is available, the method 500 moves to block 555, where the system treats both the source and target tables as single logical blocks, bypassing further partitioning. In this configuration, the Partitioner thread sets the Num_Blocks value to 1 and generates a single query to retrieve the entire dataset from each table. The fallback operation at block 555 allows the data comparison process to proceed without interruption, even in the absence of shared partitioning attributes or indexes.

As discussed above, when one or both input tables are non-partitioned tables, the method 500 moves to block 560 (as depicted in FIG. 5B). Turning to FIG. 5B, at block 560, the Partitioner thread evaluates the available indexes in the source and/or target tables. This may include scanning the metadata of tables to locate indexes that can serve as partitioning attributes for logical data division. The indexes may include single-column indexes, such as IDX_OrderDate, or multi-column indexes, such as IDX_CustomerID_OrderDate.

At block 565, the Partitioner thread determines whether any of the identified indexes are shared by both source and target tables. If only one index exists and is shared by both tables, the method 500 proceeds to block 570, where the Partitioner thread directly uses this index (e.g., IDX_OrderDate) for data division. If multiple shared indexes exist, the Partitioner thread evaluates each index and selects the one with the lowest number of columns. This selection simplifies the partitioning process and reduces processing overhead. For example, when two shared indexes are identified, IDX_CustomerID_OrderDate (which is defined on the CustomerID column and OrderDate column) and IDX_CustomerID (which is defined on the CustomerID column only), the thread selects IDX_CustomerID because it involves fewer columns and therefore leads to simpler queries and faster partitioning and comparison operations.

If no index is shared by both tables, the method 500 moves to block 555, where the thread treats each of the input tables as a single logical blocks. In this configuration, the Partitioner thread sets the Num_Blocks value to 1 and generates a single query for each table to retrieve the entire dataset.

FIG. 6 depicts an example method 600 for determining boundary value sets for a selected chunk-based column list, according to some embodiments of the present disclosure. The example method 600 may be performed by any computing device or system, such as the tParitioner thread 325 as depicted in FIG. 3. This method may be executed after the chunk-based attributes or columns have been identified, as depicted in FIGS. 5A and 5B.

At block 605, the Partitioner thread calculates the boundary values for each partition based on the chunk-based attributes or columns (e.g., CustomerID column) that have been identified. These boundary values define the range or subsets of data to be included within each logical partition. The calculation process may follow the partition size rules specified in the data partition configuration table (also referred to in some embodiments as the “chunk_by table”). In some embodiments, the partition size rules in the data partition configuration table may provide additional control over how data is divided. For example, a rule may specify that each partition contains a maximum of 10,000 records (e.g., PartitionSize=10000) or that partitions should be based on date ranges spanning one month a time (e.g., DataRange=1Month). By applying such rules, the Partitioner thread divide the input tables into balanced and similar-sized chunks. If no explicit partition size rules is defined in the data partition configuration table, the Partitioner thread defaults to dividing the data evenly based on distribution of values in the identified chunk-based columns.

At block 610, the tParitioner thread generates SQL queries for data retrieval based on the determined boundary value sets for each partition. These queries are configured to fetch data from both the source and target tables for each logical partition. For example, if the partition is defined by an OrderDate column with a range of January 1 to January 31, the queries may look like: SELECT*FROM SourceTable WHERE OrderDate BETWEEN ‘2023-01-01’ AND ‘2023-01-31’; SELECT*FROM TargetTable WHERE OrderDate BETWEEN ‘2023-01-01’ AND ‘2023-01-31’.

At block 615, the Partitioner thread queues the generated queries for execution. The queueing mechanism organizes the queries and prepares them for parallel execution. In some embodiments, each query in the queue may be associated with metadata, such as the partition ID, boundary values, and source/target table identifies. The association maintains clear tracking and coordination during query execution.

At block 620, the queued queries are sent and distributed to one or more Combiner threads (e.g., 335 of FIG. 3). In some embodiments, the Partitioner may send queries in parallel, allowing multiple Combiner threads processing different partitions simultaneously. Each Combiner thread may receive a query, execute the query to fetch the corresponding data from the source and target tables, and perform record-by-record data comparison. When discrepancies are detected during the comparison process, the Combiner threads may categorize the discrepancies based on their type (e.g., mismatched values, extra or missing records) and report the discrepancies to the DiffReporter thread (e.g., 330 of FIG. 3). The DiffReporter thread may then aggregate the detected discrepancies from all Combiner threads and generate a final report.

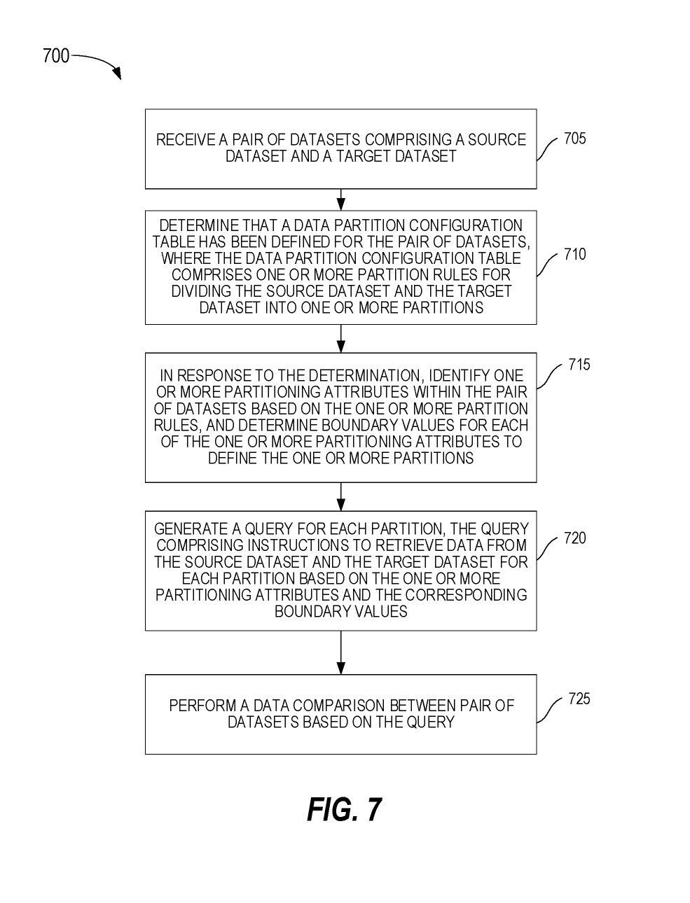

FIG. 7 is a flow diagram depicting an example method 700 for chunk-based data partitioning, according to some embodiments of the present disclosure.

At block 705, a computing system (e.g., Partitioner thread) receives a pair of datasets comprising a source dataset and a target dataset (e.g., 340 of FIG. 3).

At block 710, the computing system determines that a data partition configuration table (e.g., chunk_by table) has been defined for the pair of datasets, where the data partition configuration table includes one or more partitioning rules for dividing the source dataset and the target dataset into one or more partitions.

At block 715, in response to the determination, the computing system identifies one or more partitioning attributes (e.g., 345 of FIG. 3) within the pair of datasets based on the one or more partitioning rules, and determines boundary values for each of the one or more partitioning attributes (e.g., 450 of FIG. 3) to define the one or more partitions.

At block 720, the computing system generates a query for each partition, the query comprising instructions to retrieve data from the source dataset and the target dataset for each partition based on the one or more partitioning attributes and the corresponding boundary values.

At block 725, the computing system (e.g., Combiner thread 335 of FIG. 3) performing a data comparison between pair of datasets based on the query.

In some embodiments, the process of performing the data comparison may include retrieving data for the first partition from the source dataset and the target dataset, determining that one or more discrepancies exist for the first partition by comparing the retrieved data from the source dataset and the target dataset, and in response to the determination, generating a discrepancy report (e.g., by the DiffReporter thread 330 of FIG. 3).

In some embodiments, the method may further include classifying the one or more discrepancies into one or more categories, comprising at least one of missing records in the target dataset, mismatched values between the source dataset and the target dataset, or extra records in the target dataset, and triggering a remediation operation on the target dataset based on the categorized discrepancies.

In some embodiments, the one or more partitioning rules may include at least one of a rule for selecting a partitioning attribute or a rule for defining a partition size.

In some embodiments, the source dataset and the target dataset each may include a partitioned table. In this configuration, the process of identifying the one or more partitioning attributes may include at least one of: in response to determining that the source dataset and the target dataset have a shared partitioning key, using the partition key as the partitioning attribute, in response to an absence of the shared partitioning key, using a non-partitioned index (NPI) that spans the source and target datasets as the partitioning attribute, or in response to an absence of the shared partitioning and the NPI, treating the source dataset and the target dataset each as a single partition.

In some embodiments, at least one of the source dataset or the target dataset may include a non-partitioned table. In this configuration, the process of identifying the one or more partitioning attributes may include, identifying a plurality of indexes established for the source dataset and the target dataset, in response to determining that the source dataset and the target dataset have one or more shared indexes, among the plurality of indexes, selecting a first index from the one or more shared indexes, where the first index has a lowest number of corresponding columns, and determining the columns corresponding to the first index as the partitioning attributes.

In some embodiments, at least one of the source dataset or the target dataset may include a non-partitioned table. In this configuration, the process of identifying the one or more partitioning attributes may include identifying a plurality of indexes established for the source dataset and the target dataset, and in response to an absence of a shared index, among the plurality of indexes, between the source dataset and the target dataset, treating the source dataset and the target dataset each as a single partition.

While the foregoing is directed to embodiments of the present disclosure, other and further embodiments of the disclosure may be devised without departing from the basic scope thereof, and the scope thereof is determined by the claims that follow.

What is claimed is:

1. A method, comprising:
receiving a pair of datasets comprising a source dataset and a target dataset;
determining that a data partition configuration table has been defined for the pair of datasets, wherein the data partition configuration table comprises one or more partitioning rules for dividing the source dataset and the target dataset into one or more partitions;
in response to the determination:
identifying one or more partitioning attributes within the pair of datasets based on the one or more partitioning rules, and
determining boundary values for each of the one or more partitioning attributes to define the one or more partitions;
generating a query for each partition, the query comprising instructions to retrieve data from the source dataset and the target dataset for each partition based on the one or more partitioning attributes and the corresponding boundary values; and
performing a data comparison between pair of datasets based on the query.

2. The method of claim 1, wherein performing the data comparison comprises:
retrieving data for a first partition from the source dataset and the target dataset;
determining that one or more discrepancies exist for the first partition by comparing the retrieved data from the source dataset and the target dataset; and
in response to the determination, generating a discrepancy report.

3. The method of claim 2, further comprising:
classifying the one or more discrepancies into one or more categories, comprising at least one of missing records in the target dataset, mismatched values between the source dataset and the target dataset, or extra records in the target dataset; and
triggering a remediation operation on the target dataset based on the categorized discrepancies.

4. The method of claim 1, wherein the one or more partitioning rules comprise at least one of a rule for selecting a partitioning attribute or a rule for defining a partition size.

5. The method of claim 1, wherein the source dataset and the target dataset each comprise a partitioned table, and wherein identifying the one or more partitioning attributes comprises at least one of:
in response to determining that the source dataset and the target dataset have a shared partitioning key, using the partition key as the partitioning attribute;
in response to an absence of the shared partitioning key, using a non-partitioned index (NPI) that spans the source and target datasets as the partitioning attribute; or
in response to an absence of the shared partitioning and the NPI, treating the source dataset and the target dataset each as a single partition.

6. The method of claim 1, wherein at least one of the source dataset or the target dataset comprises a non-partitioned table, and wherein identifying the one or more partitioning attributes comprises:
identifying a plurality of indexes established for the source dataset and the target dataset;
in response to determining that the source dataset and the target dataset have one or more shared indexes, among the plurality of indexes, selecting a first index from the one or more shared indexes, wherein the first index has a lowest number of corresponding columns; and
determining the columns corresponding to the first index as the partitioning attributes.

7. The method of claim 1, wherein at least one of the source dataset or the target dataset comprises a non-partitioned table, and wherein identifying the one or more partitioning attributes comprises:
identifying a plurality of indexes established for the source dataset and the target dataset; and
in response to an absence of a shared index, among the plurality of indexes, between the source dataset and the target dataset, treating the source dataset and the target dataset each as a single partition.

8. A system, comprising:
one or more memories collectively containing one or more programs; and
one or more processors, wherein the one or more processors are configured to, individually or collectively, perform an operation comprising:
receiving a pair of datasets comprising a source dataset and a target dataset;
determining that a data partition configuration table has been defined for the pair of datasets, wherein the data partition configuration table comprises one or more partitioning rules for dividing the source dataset and the target dataset into one or more partitions;
in response to the determination:
identifying one or more partitioning attributes within the pair of datasets based on the one or more partitioning rules, and
determining boundary values for each of the one or more partitioning attributes to define the one or more partitions;
generating a query for each partition, the query comprising instructions to retrieve data from the source dataset and the target dataset for each partition based on the one or more partitioning attributes and the corresponding boundary values; and
performing a data comparison between pair of datasets based on the query.

9. The system of claim 8, wherein performing the data comparison comprises:
retrieving data for a first partition from the source dataset and the target dataset;
determining that one or more discrepancies exist for the first partition by comparing the retrieved data from the source dataset and the target dataset; and
in response to the determination, generating a discrepancy report.

10. The system of claim 9, wherein the operation further comprises:
classifying the one or more discrepancies into one or more categories, comprising at least one of missing records in the target dataset, mismatched values between the source dataset and the target dataset, or extra records in the target dataset; and
triggering a remediation operation on the target dataset based on the categorized discrepancies.

11. The system of claim 8, wherein the one or more partitioning rules comprise at least one of a rule for selecting a partitioning attribute or a rule for defining a partition size.

12. The system of claim 8, wherein the source dataset the target dataset each comprise a partitioned table, and wherein identifying the one or more partitioning attributes comprises at least one of:
in response to determining that the source dataset and the target dataset have a shared partitioning key, using the partition key as the partitioning attribute;
in response to an absence of the shared partitioning key, using a non-partitioned index (NPI) that spans the source and target datasets as the partitioning attribute; or
in response to an absence of the shared partitioning and the NPI, treating the source dataset and the target dataset each as a single partition.

13. The system of claim 8, wherein at least one of the source dataset or the target dataset comprises a non-partitioned table, and wherein identifying the one or more partitioning attributes comprises:
identifying a plurality of indexes established for the source dataset and the target dataset;
in response to determining that the source dataset and the target dataset have one or more shared indexes, among the plurality of indexes, selecting a first index from the one or more shared indexes, wherein the first index has a lowest number of corresponding columns; and
determining the columns corresponding to the first index as the partitioning attributes.

14. The system of claim 8, wherein at least one of the source dataset or the target dataset comprises a non-partitioned table, and wherein identifying the one or more partitioning attributes comprises:
identifying a plurality of indexes established for the source dataset and the target dataset; and
in response to an absence of a shared index, among the plurality of indexes, between the source dataset and the target dataset, treating the source dataset and the target dataset each as a single partition.

15. One or more computer-readable media containing, in any combination, computer program code that, when executed by a computer system, performs an operation comprising:
receiving a pair of datasets comprising a source dataset and a target dataset;
determining that a data partition configuration table has been defined for the pair of datasets, wherein the data partition configuration table comprises one or more partitioning rules for dividing the source dataset and the target dataset into one or more partitions;
in response to the determination:
identifying one or more partitioning attributes within the pair of datasets based on the one or more partitioning rules, and
determining boundary values for each of the one or more partitioning attributes to define the one or more partitions;
generating a query for each partition, the query comprising instructions to retrieve data from the source dataset and the target dataset for each partition based on the one or more partitioning attributes and the corresponding boundary values; and
performing a data comparison between pair of datasets based on the query.

16. The one or more computer-readable media of claim 15, wherein performing the data comparison comprises:
retrieving data for a first partition from the source dataset and the target dataset;
determining that one or more discrepancies exist for the first partition by comparing the retrieved data from the source dataset and the target dataset; and
in response to the determination, generating a discrepancy report.

17. The one or more computer-readable media of claim 16, wherein the operation further comprises:
classifying the one or more discrepancies into one or more categories, comprising at least one of missing records in the target dataset, mismatched values between the source dataset and the target dataset, or extra records in the target dataset; and
triggering a remediation operation on the target dataset based on the categorized discrepancies.

18. The one or more computer-readable media of claim 15, wherein the source dataset and the target dataset each comprise a partitioned table, and wherein identifying the one or more partitioning attributes comprises at least one of:
in response to determining that the source dataset and the target dataset have a shared partitioning key, using the partition key as the partitioning attribute;
in response to an absence of the shared partitioning key, using a non-partitioned index (NPI) that spans the source and target datasets as the partitioning attribute; or
in response to an absence of the shared partitioning and the NPI, treating the source dataset and the target dataset each as a single partition.

19. The one or more computer-readable media of claim 15, wherein at least one of the source dataset or the target dataset comprises a non-partitioned table, and wherein identifying the one or more partitioning attributes comprises:
identifying a plurality of indexes established for the source dataset and the target dataset;
in response to determining that the source dataset and the target dataset have one or more shared indexes, among the plurality of indexes, selecting a first index from the one or more shared indexes, wherein the first index has a lowest number of corresponding columns; and
determining the columns corresponding to the first index as the partitioning attributes.

20. The one or more computer-readable media of claim 15, wherein at least one of the source dataset or the target dataset comprises a non-partitioned table, and wherein identifying the one or more partitioning attributes comprises:
identifying a plurality of indexes established for the source dataset and the target dataset; and
in response to an absence of a shared index, among the plurality of indexes, between the source dataset and the target dataset, treating the source dataset and the target dataset each as a single partition.
